(19) United States
(12) Patent Application Publication
(10) Pub. No.: US 2007/0132761 A1
(43) Pub. Date: Jun. 14, 2007

(54) Signal measuring device

(75) Inventors: Yoshihide Maruyama, Gunma (JP); Hiroshi Nagasawa, Gunma (JP); Tsutomu Kumazawa, Gunma (JP); Hiroaki Takaoku, Gunma (JP)

Correspondence Address: GREENBLUM & BERNSTEIN, P.L.C., 1950 ROLAND CLARKE PLACE, RESTON, VA, 20191, US

(73) Assignee: ADVANTEST CORPORATION, Tokyo (JP)

(21) Appl. No.: 10/556,352

(22) PCT Filed: May 12, 2004
(86) PCT No.: PCT/JP04/06710

§ 371 Date: Apr. 10, 2006

(30) Foreign Application Priority Data
May 15, 2003 (JP) 2003-137392

(51) Int. Cl. G09G 5/22

(52) U.S. Cl. 345/440.1

(57) ABSTRACT

It is possible to easily set the operation of a spectrum analyzer. The spectrum analyzer receives a signal to be measured. The spectrum analyzer includes a display device (28) having a display screen for displaying the signal to be measured with a vertical axis representing a measurement value (power) of the signal to be measured and a horizontal axis representing frequency. Furthermore, a touch panel is provided on the display screen of the display device (28). When a user of the spectrum analyzer touches a point 32a (f0, P0) on the display screen, peak search is performed to detect a maximal value of the measurement value of the signal to be measured in a range of the vicinity of the touched point (frequency f1 to f2, power P1 to P2) (wherein f1=f0−Δf, f2=f0+Δf, P1=P0−ΔP, P2=P0+ΔP). Thus, it is possible to easily set the range for performing the peak search.

### TECHNICAL FIELD

The present invention relates to setting of operations of a spectrum analyzer.

### BACKGROUND ART

Conventionally, a spectrum analyzer has been used to measure the frequency of a signal. The spectrum analyzer displays a result of the measurement of the signal as a chart with the power being assigned to the vertical axis, and the frequency being assigned to the horizontal axis. A user of the spectrum analyzer observes the display of the spectrum analyzer to set operations of the spectrum analyzer. For example, the user sets a frequency band used to detect a peak of the power, sets an area to be zoomed in, and moves the area to be displayed up/down and left/right.

It should be noted that Japanese Laid-Open Patent Publication (Kokai) No. H10-253673 (ABSTRACT) also describes zooming in and out of a display screen of a spectrum analyzer.

However, it requires a large amount of labor to set the operations carried out by the spectrum analyzer. Namely, it is necessary to properly operate various buttons and knobs provided upon the spectrum analyzer.

It is an object of the present invention to simplify the setting of operations carried out by a spectrum analyzer.

### DISCLOSURE OF THE INVENTION

According to the present invention as described in claim 1, a signal measurement/display device includes: a measuring unit that measures a signal to be measured for respective frequencies, and outputs a measurement value; a displaying unit that displays the signal to be measured with the measurement value being assigned to one axis, and the frequency being assigned to the other axis; a portion specifying unit that specifies a portion upon a display screen of the displaying unit; and an operation deciding unit that decides an operation of the measuring unit or the displaying unit based upon the portion specified by the portion specifying unit.

According to the thus constructed invention, a measuring unit measures a signal to be measured for respective frequencies, and outputs a measurement value. A displaying unit displays the signal to be measured with the measurement value being assigned to one axis, and the frequency being assigned to the other axis. A portion specifying unit specifies a portion upon a display screen of the displaying unit. An operation deciding unit decides an operation of the measuring unit or the displaying unit based upon the portion specified by the portion specifying unit.

The present invention as described in claim 2, is the signal measurement/display device according to claim 1, wherein the portion specifying unit specifies the portion according to a touch to the display screen.

The present invention as described in claim 3, is the signal measurement/display device according to claim 1, wherein the portion specifying unit specifies the portion by moving a marker upon the display screen according to a manipulated variable.

The present invention as described in claim 4, is the signal measurement/display device according to any one of claims 1 to 3, wherein the operation deciding unit decides a detection range for the measuring unit to detect a maximal value of the measurement value based upon the portion specified by the portion specifying unit.

The present invention as described in claim 5, is the signal measurement/display device according to claim 4, wherein the operation deciding unit decides the detection range based upon a value obtained by adding or subtracting a predetermined value to or from a coordinate of the portion specified by the portion specifying unit.

The present invention as described in claim 6, is the signal measurement/display device according to claim 4, wherein the operation deciding unit decides the detection range based upon an area enclosed by the portions specified by the portion specifying unit.

The present invention as described in claim 7, is the signal measurement/display device according to any one of claims 1 to 3, wherein the operation deciding unit causes the displaying unit to zoom in or out the signal to be measured based upon the portions specified by the portion specifying unit.

The present invention as described in claim 8, is the signal measurement/display device according to claim 7, wherein the operation deciding unit zooms in the signal to be measured between frequency components of coordinates of two portions specified by the portion specifying unit.

The present invention as described in claim 9, is the signal measurement/display device according to any one of claims 1 to 3, wherein the operation deciding unit scrolls an area for the displaying unit to display the signal to be measured based upon the portion specified by the portion specifying unit.

The present invention as described in claim 10, is the signal measurement/display device according to claim 9, wherein the operation deciding unit scrolls the area for the displaying unit to display the signal to be measured based upon a position of the portion specified by the portion specifying unit upon the display screen.

The present invention as described in claim 11, is a signal measurement/display method of a signal measurement/display device having: a measuring unit that measures a signal to be measured for respective frequencies, and outputs a measurement value; a displaying unit that displays the signal to be measured with the measurement value being assigned to one axis, and the frequency being assigned to the other axis; and a portion specifying unit that specifies a portion upon a display screen of the displaying unit, the method including: an operation deciding step of deciding an operation of the measuring unit or the displaying unit based upon the portion specified by the portion specifying unit.

### BRIEF DESCRIPTION OF THE DRAWINGS

FIG. 1 is a block diagram showing a configuration of a spectrum analyzer (signal measurement/display device) 1 according a first embodiment of the present invention;

FIG. 2 is an example of a display screen of the display device 28;

FIG. 3 is a diagram showing methods to specify a portion by means of the touch panel 32;

FIG. 4 is a diagram showing methods to specify a portion by means of the pointing device 34;

FIG. 5 shows how to specify a detection range for a peak judgment area decision section 38;

FIG. 6 is a block diagram showing a configuration of the spectrum analyzer (signal measurement/display device) 1 according a second embodiment of the present invention;

FIG. 7(a) is a diagram showing methods to specify a portion by means of the touch panel 32, and FIG. 7(b) is a diagram showing methods to specify a portion by means of the pointing device 34;

FIG. 8 is a diagram showing an occasion where the respective points 32c and 32d are specified by the finger;

FIG. 9 is a diagram showing a zoomed in display screen;

FIG. 10 is a block diagram showing a configuration of the spectrum analyzer (signal measurement/display device) 1 according to a third embodiment of the present invention;

FIG. 11 illustrates how to specify a portion by means of the touch panel 32;

FIG. 12 is a diagram showing a display screen when the display area is moved right; and

FIG. 13 is a diagram showing a display screen when the display area is moved down.

### BEST MODE FOR CARRYING OUT THE INVENTION

A description will now be given of embodiments of the present invention with reference to drawings.

### First Embodiment

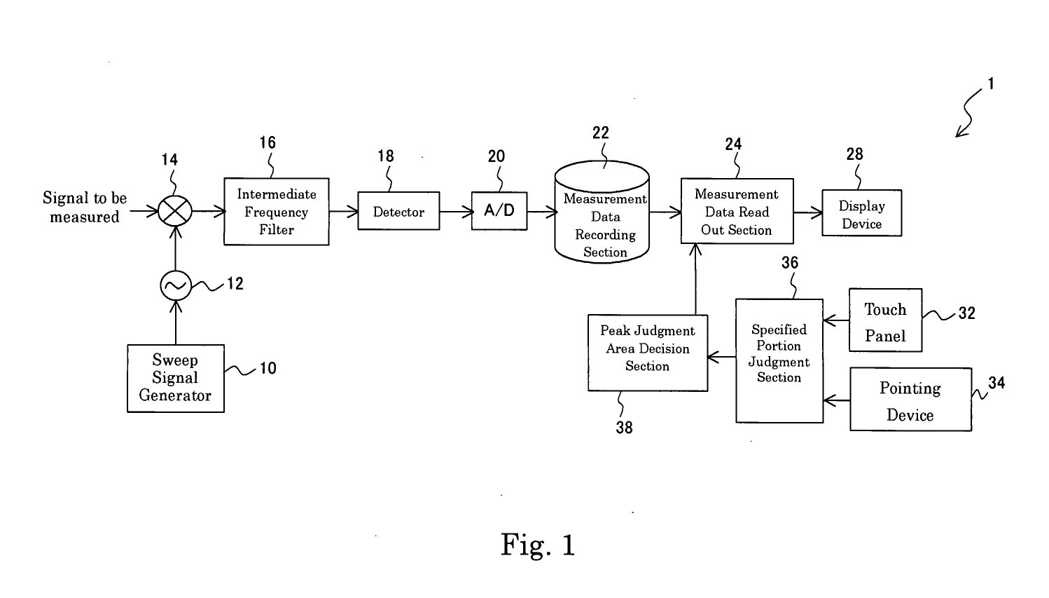

FIG. 1 is a block diagram showing a configuration of a spectrum analyzer (signal measurement/display device) 1 according a first embodiment of the present invention. The spectrum analyzer (signal measurement/display device) 1 according to the first embodiment is provided with a sweep signal generator 10, a local oscillator 12, a mixer 14, an intermediate frequency filter 16, a detector (measuring means) 18, an A/D converter 20, a measurement data recording section 22, a measurement data read out section (measuring means) 24, a display device (displaying means) 28, a touch panel (portion specifying means) 32, a pointing device (portion specifying means) 34, a specified portion judgment section 36, and a peak judgment area decision section (operation deciding means) 38.

The sweep signal generator 10 generates a sweep signal used to sweep the frequency of a local signal generated by a local oscillator 12. The sweep signal is supplied to the local oscillator 12.

The local oscillator 12 generates the local signal. The frequency of the local signal varies according to the sweep signal. Namely, a frequency sweep is carried out. The local signal is supplied to the mixer 14.

The mixer 14 is a multiplier which mixes a signal to be measured and the local signal, and output a result of the mixing.

The intermediate frequency filter 16 extracts a signal with a predetermined intermediate frequency from the output of the mixer 14.

The detector (measuring means) 18 detects the signal extracted by the intermediate frequency filter 16. As a result of the detection, a power is obtained for respective frequencies of the signal to be measured.

The A/D converter 20 converts the output (which is an analog signal) from the detector 18 into a digital signal.

The measurement data recording section 22 records the output from the A/D converter 20. Recorded contents in the measurement data recording section 22 are referred to as measurement data. The measurement data represents correspondence of the measurement values (powers) of the signal to be measured, which are measured for the respective frequencies, with the frequencies.

The measurement data read out section (measuring means) 24 reads out the measurement data from the measurement data recording section 22. It should be noted that the measurement data read out section 24 also detects a maximal value of the power of the signal detected by the detector 18 based upon the measurement data recorded in the measurement data recording section 22. It should be noted that ranges of the frequency and the power used by the measurement data read out section 24 to detect the maximal value is decided by the peak judgment area decision section 38.

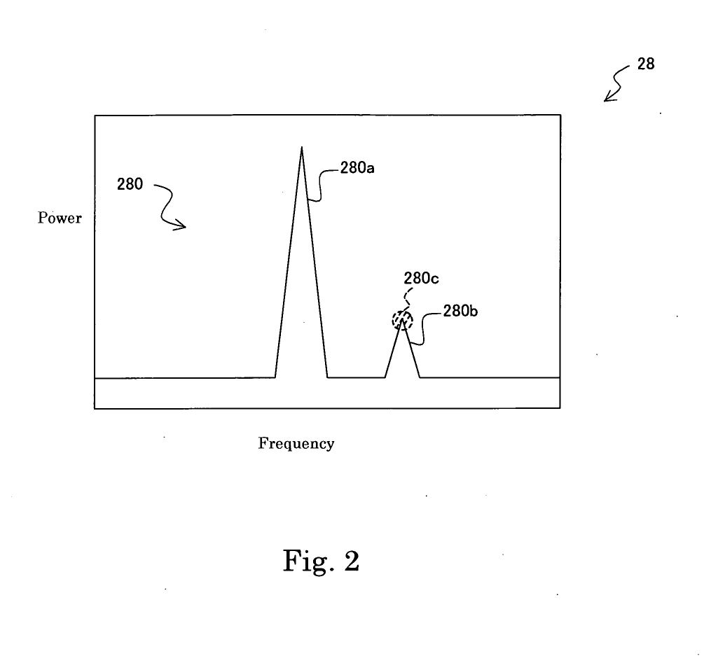

The display device (displaying means) 28 displays an output from the measurement data read out section 24. FIG. 2 shows an example of a display screen of the display device 28. The display device 28 displays the signal to be measured with the power being assigned to the vertical axis, and the frequency being assigned to the horizontal axis. The displayed chart is referred to as a spectrum 280. In an example shown in FIG. 2, the spectrum 280 includes mountains 280a and 280b where the power increases. There may be a necessity to precisely recognize a peak (maximal value) 280c of the mountain 280b. In this case, the measurement data read out section 24 detects the peak.

The touch panel (portion specifying means) 32 and the pointing device (portion specifying means) 34 are used to specify a portion upon the display screen.

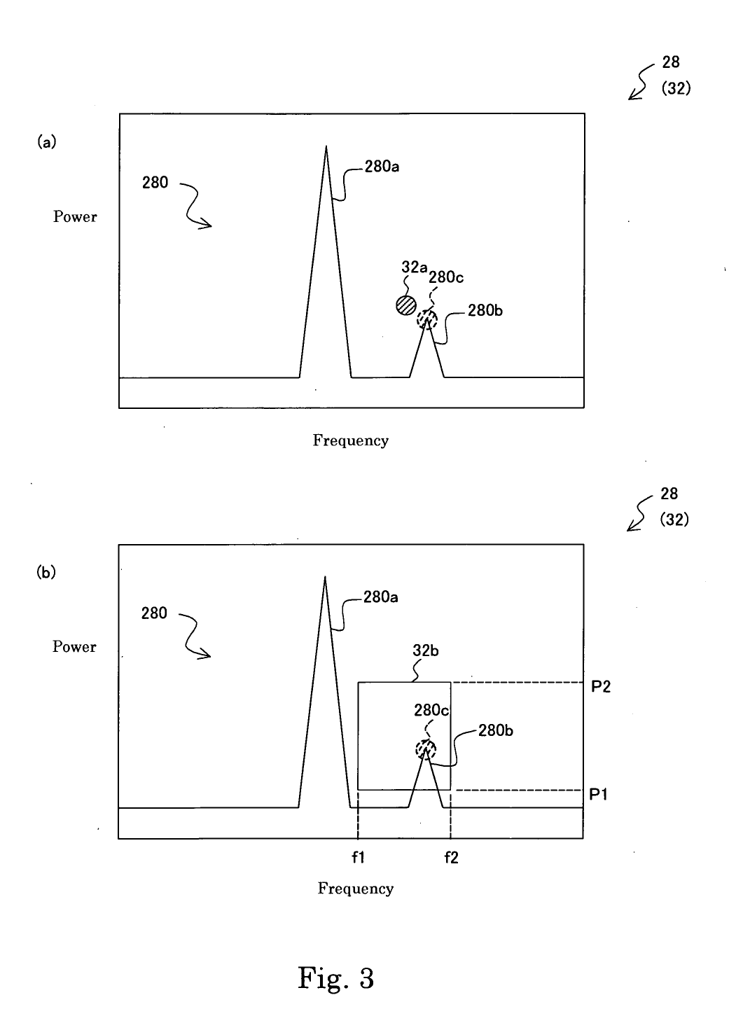

The touch panel (portion specifying means) 32 detects a touch of the finger of a user and the like. The touch panel 32 is installed upon the display screen. Thus, if the user touches the display screen by the finger or the like, the touch panel 32 detects a touched portion. There are two methods to specify a portion by means of the touch panel 32 as shown in FIG. 3. One method is carried out by touching one point 32a upon the display screen by the finger or the like as shown in FIG. 3(a). The other method is carried out by drawing a closed area 32b in a rectangular shape upon the display screen while the finger or the like is touching the display screen as shown in FIG. 3(b).

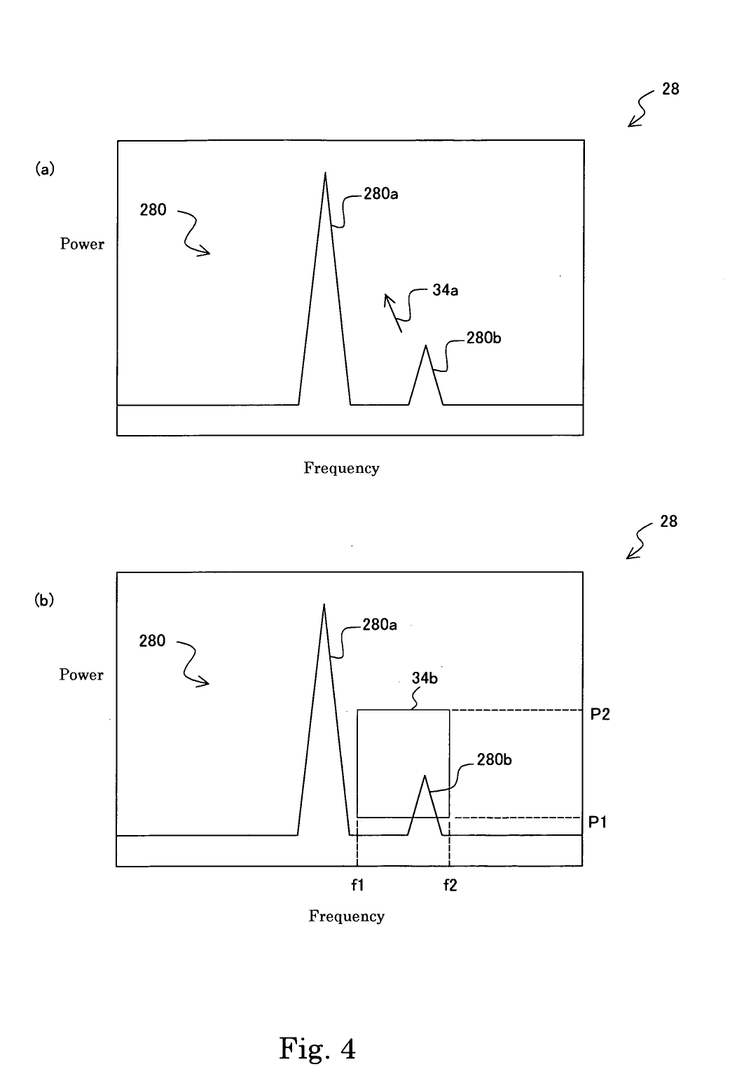

The pointing device (portion specifying means) 34 displays a marker upon the display screen, and moves the marker according to a manipulated variable thereby specifying a portion. For example, the pointing device 34 may be a mouse. If the mouse is employed, the marker moves upon the display screen according to the amount of a movement of the mouse. There are two methods to specify a portion by means of the pointing device 34 as shown in FIG. 4. One method is carried out by moving the marker to one point 34a upon the display screen as shown in FIG. 4(a). The other method is carried out by drawing a closed area 34b in a rectangular shape upon the display screen while the marker is being moved as shown in FIG. 4(b).

The specified portion judgment section 36 judges coordinates of the portion specified by the touch panel 32 and the pointing device 34.

The peak judgment area decision section (operation deciding means) 38 decides the ranges of the frequency and the power (referred to as detection ranges) used by the measurement data read out section 24 to detect the maximal value based upon the portion specified by the touch panel 32 and the pointing device 34.

If the rectangular closed area 32b or 34b is drawn by the finger or the marker, the area may be used as the detection ranges. For example, according to the examples shown in FIGS. 3(b) and 4(b), the detection ranges are specified by a range of the frequency from f1 to f2, and a range of the power from P1 to P2.

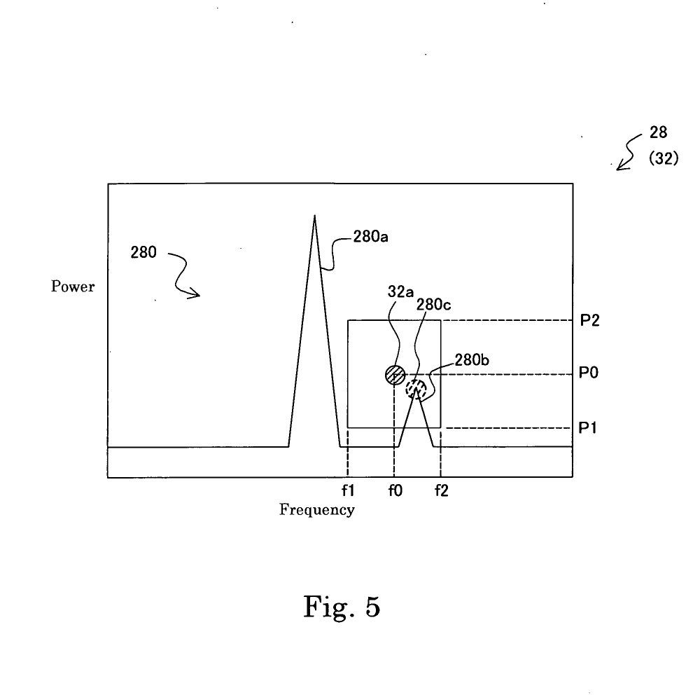

If the one point 32a (one point 34a ) is specified by the finger (marker), the detection ranges can be specified by values obtained by adding or subtracting predetermined values from coordinate values of the one point. For example, in the example shown in FIG. 5, if the coordinate of the one point 32a is represented as (f0, P0), the detection range has a range of the frequency from f1 to f2, and a range of the power from P1 to P2. It should be noted that f1=f0−Δf, f2=f0+Δf, P1=P0−ΔP, and P2=P0+ΔP.

A description will now be given of an operation of the first embodiment.

The signal to be measured is mixed with the local signal generated by the local oscillator 12 by the mixer 14. It should be noted that the local signal is frequency-swept by the sweep signal generated by the sweep signal generator 10. The intermediate frequency filter 16 extracts the signal with the predetermined intermediate frequency from the output of the mixer 14. The signal with the predetermined intermediate frequency is detected by the detector 18 to acquire the power for the respective frequencies of the signal to be measured. The measured power is converted into the digital signal by the A/D converter 20, and is recorded in the measurement data recording section 22. It should be noted that the measured power is associated with the frequency and is recorded as the measurement data. The measurement data is read out by the measurement data read out section 24. The signal to be measured is then displayed by the display device 28 as the chart with the power being assigned to the vertical axis, and the frequency being assigned to the horizontal axis (refer to FIG. 2).

On this occasion, it is assumed that the user of the spectrum analyzer 1 wants to know the precise value of the power at the peak (maximal value) 280c of the mountain 280b.

Then, the user touches the one point 32a close to the peak (maximal value) 280c upon the display screen by the finger (refer to FIG. 3(a)), or draws the closed area 32b in the rectangular shape enclosing the peak (maximal value) 280c upon the display screen (refer to FIG. 3(b)). The touch panel 32 installed upon the display screen then detects the touch of the finger. The specified portion judgment section 36 judges the coordinate of the portion specified by the touch panel 32. The peak judgment area decision section 38 specifies the values obtained by the addition to or the subtraction from the coordinate values of the one point 32a (refer to FIG. 5) or the area 32b as the detection ranges.

Alternatively, the user moves the marker upon the display screen to the one point 34a close to the peak (maximal value) 280c upon the display screen (refer to FIG. 4(a)), or draws the closed area 34b in the rectangular shape enclosing the peak (maximal value) 280c using the marker upon the display screen (refer to FIG. 4(b)). The specified portion judgment section 36 then judges coordinates of the portion specified by the pointing device 34. The peak judgment area decision section 38 specifies the values obtained by the addition to or the subtraction from the coordinates of the one point 34a (refer to FIG. 5) or the area 34b as the detection ranges.

The measurement data read out section 24 detects the maximal value of the power of the signal detected by the detector 18 within the detection ranges. Namely, the measurement data read out section 24 detects the maximal value of the power (power at the peak (maximal value) 280c) of the mountain 280b (refer to FIG. 2). The maximal value is converted into the digital signal by the A/D converter 20, and is recorded in the measurement data recording section 22. Then, the maximal value is read out by the measurement data read out section 24. Then, the maximal value is displayed by the display device 28.

According to the first embodiment, it is possible to set the detection ranges of the measurement data read out section 24 by touching the display screen by the finger or moving the marker using the pointing device 34 such as the mouse. Thus, the detection ranges can be easily set.

### Second Embodiment

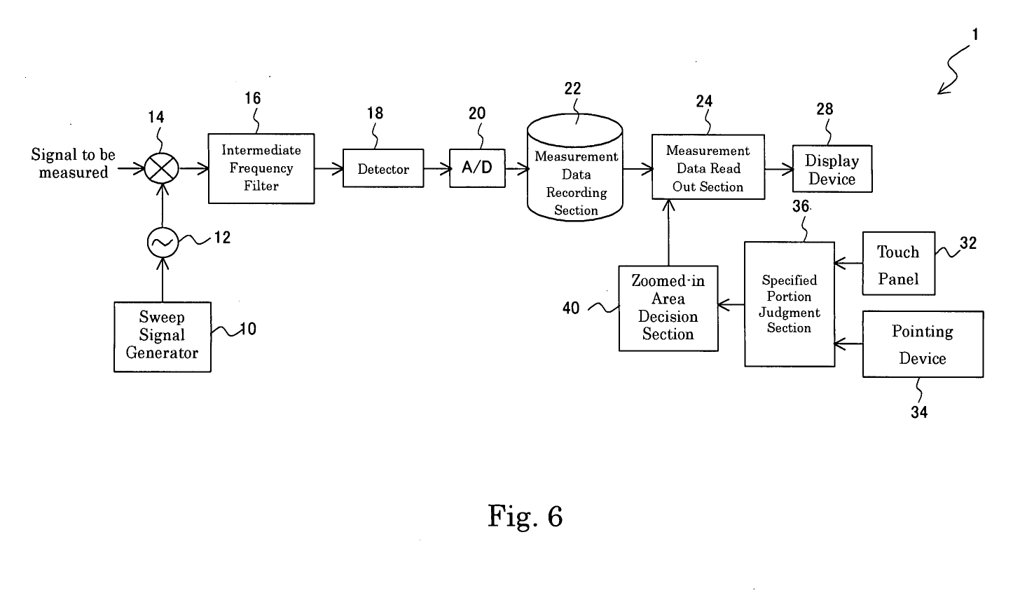

FIG. 6 is a block diagram showing a configuration of the spectrum analyzer (signal measurement/display device) 1 according a second embodiment of the present invention. The spectrum analyzer (signal measurement/display device) 1 according to the second embodiment is provided with the sweep signal generator 10, the local oscillator 12, the mixer 14, the intermediate frequency filter 16, the detector (measuring means) 18, the A/D converter 20, the measurement data recording section 22, the measurement data read out section 24, the display device (displaying means) 28, the touch panel (portion specifying means) 32, the pointing device (portion specifying means) 34, the specified portion judgment section 36, and a zoomed-in area decision section (operation deciding means) 40. In the following section, like components are denoted by like numerals as of the first embodiment, and will be explained in no more details.

The sweep signal generator 10, the local oscillator 12, the mixer 14, the intermediate frequency filter 16, the detector (measuring means) 18, the A/D converter 20, the measurement data recording section 22, the measurement data read out section 24, and the display device (displaying means) 28 are similar to those of the first embodiment.

The touch panel (portion specifying means) 32 and the pointing device (portion specifying means) 34 are used to specify a portion upon the display screen.

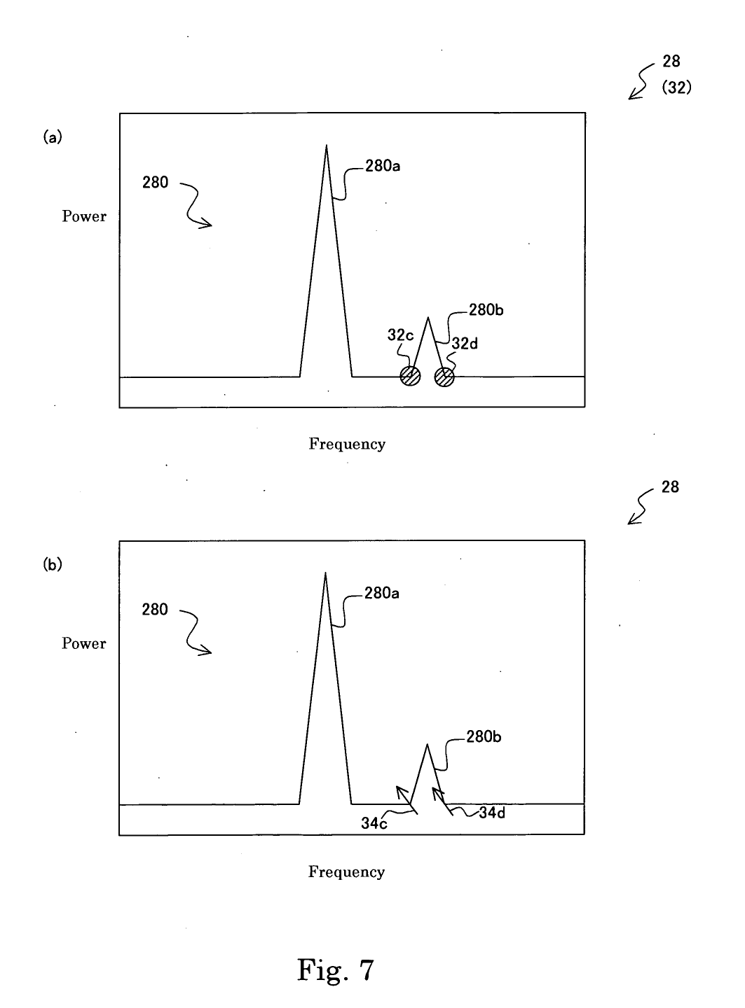

The touch panel (portion specifying means) 32 detects a touch of the finger of the user and the like. The touch panel 32 is installed upon the display screen. Thus, if the user touches the display screen by the finger or the like, the touch panel 32 detects a touched portion. A method of specifying a portion by means of the touch panel 32 is carried out by touching respective points 32c and 32d upon the display screen by the finger or the like as shown in FIG. 7(a).

The pointing device (portion specifying means) 34 displays the marker upon the display screen, and moves the marker according to a manipulated variable thereby specifying a portion. For example, the pointing device 34 may be a mouse. If the mouse is employed, the marker moves upon the display screen according to the amount of a movement of the mouse. A method of specifying a portion by means of the pointing device 34 is carried out to move the marker to respective points 34c and 34d upon the display screen as shown in FIG. 7(b).

The specified portion judgment section 36 judges coordinates of the portions specified by the touch panel 32 and the pointing device 34.

The zoomed-in area decision section (operation deciding means) 40 decides an area in which the signal to be measured is zoomed in by the display device 28 based upon the portions specified by the touch panel 32 and the pointing device 34. The decided area is transmitted to the measurement data read out section 24, and the measurement data read out section 24 reads out measurement data within the area.

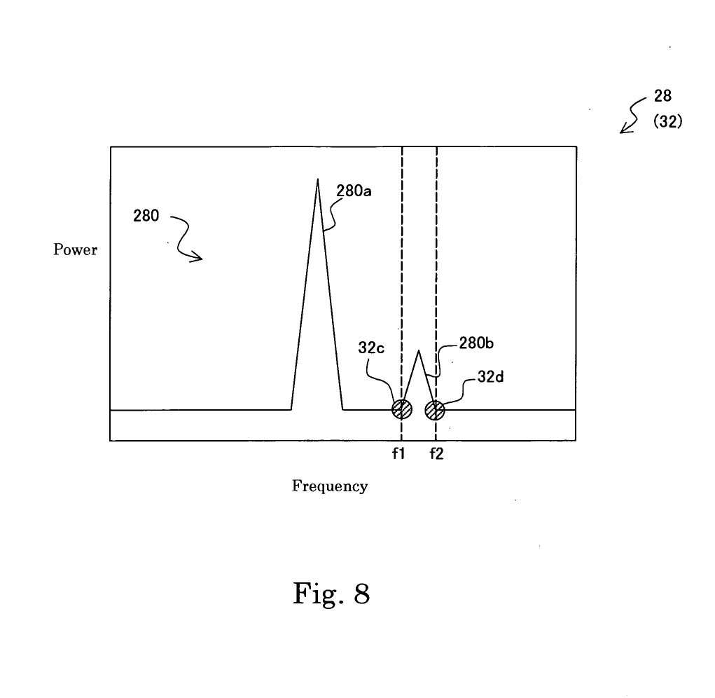

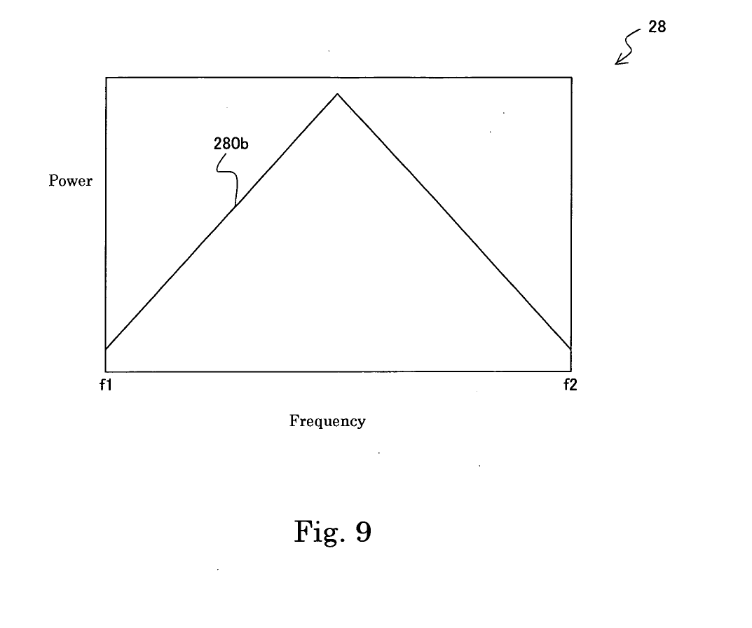

If the respective points 32c and 32d are specified by the finger, the signal to be measured is zoomed in between frequency components of the coordinates of the respective points. For example, in an example in FIG. 8, if it is assumed that the frequency component of the coordinate of the one point 32c is f1, and the frequency component of the coordinate of the one point 32d is f2, a portion with the frequency from f1 to f2 is displayed as in FIG. 9. Namely, portions with the frequency less than f1 or more than f2 are not shown. It should be noted that the display is carried out in a similar manner for the case where the marker is moved to the respective points 34c and 34d upon the display screen.

A description will now be given of an operation of the second embodiment.

The signal to be measured is mixed with the local signal generated by the local oscillator 12 by the mixer 14. It should be noted that the local signal is frequency-swept by the sweep signal generated by the sweep signal generator 10. The intermediate frequency filter 16 extracts the signal with the predetermined intermediate frequency from the output of the mixer 14. The signal with the predetermined intermediate frequency is detected by the detector 18 to acquire the power for the respective frequencies of the signal to be measured. The measured power is converted into the digital signal by the A/D converter 20, and is recorded in the measurement data recording section 22. It should be noted that the measured power is associated with the frequency and is recorded as the measurement data. The measurement data is read out by the measurement data read out section 24. The signal to be measured is then displayed by the display device 28 as the chart with the power being assigned to the vertical axis, and the frequency being assigned to the horizontal axis (refer to FIG. 2).

On this occasion, it is assumed that the user of the spectrum analyzer 1 wants to zoom in the portion of the mountain 280b.

Then, the user specifies the respective points 32c and 32d by the finger upon the display screen (refer to FIG. 7(a)). The touch panel 32 installed upon the display screen then detects the touches of the finger. The specified portion judgment section 36 judges coordinates of the portions specified by the touch panel 32. The zoomed-in area decision section 40 decides to zoom in the signal to be measured between the frequency components of the coordinates of the respective points 32c and 32d (refer to FIG. 8), and transmits the decided area to the measurement data read out section 24.

Alternatively, the user moves the marker to the respective points 34c and 34d upon the display screen (refer to FIG. 7(b)). The specified portion judgment section 36 then judges coordinates of the portions specified by the pointing device 34. The zoomed-in area decision section 40 decides to zoom in the signal to be measured between the frequency components of the coordinates of the respective points 34c and 34d, and transmits the decided area to the measurement data read out section 24.

The measurement data read out section 24 reads out the data to be measured from the frequency f1 to f2. The data to be measured, which is read out by the measurement data read out section 24, is displayed by the display device 28. Since the area from the frequency f1 to f2 includes the mountain 280b, and the mountain 280b is zoomed in (refer to FIG. 9).

According to the second embodiment, it is possible to set a portion to be zoomed in by touching the display screen by the finger or moving the marker using the pointing device 34 such as the mouse. Thus, the zoom-in display can be easily set.

It should be noted that, on an occasion as shown in FIG. 9, if a specific area upon the display screen is touched by the finger, or the marker is moved, the display may return to the original screen display (refer to FIG. 2), namely, a zoomed-out display may be carried out.

### Third Embodiment

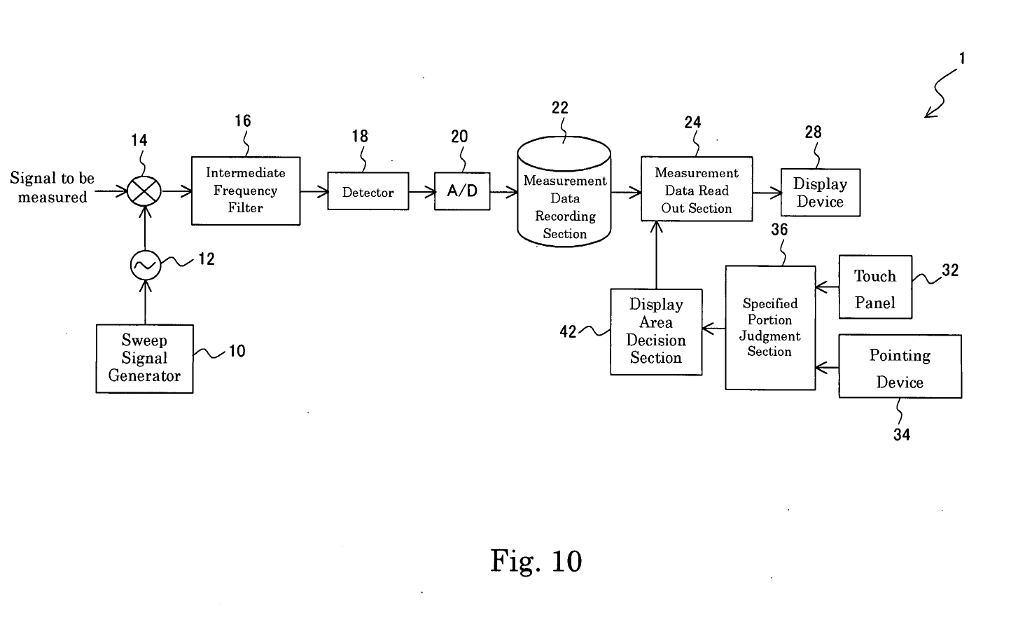

FIG. 10 is a block diagram showing a configuration of the spectrum analyzer (signal measurement/display device) 1 according to a third embodiment of the present invention. The spectrum analyzer (signal measurement/display device) 1 according to the third embodiment is provided with the sweep signal generator 10, the local oscillator 12, the mixer 14, the intermediate frequency filter 16, the detector (measuring means) 18, the A/D converter 20, the measurement data recording section 22, the measurement data read out section 24, the display device (displaying means) 28, the touch panel (portion specifying means) 32, the pointing device (portion specifying means) 34, the specified portion judgment section 36, and a display area decision section (operation deciding means) 42. In the following section, like components are denoted by like numerals as of the second embodiment, and will be explained in no more details.

The sweep signal generator 10, the local oscillator 12, the mixer 14, the intermediate frequency filter 16, the detector (measuring means) 18, the A/D converter 20, the measurement data recording section 22, the measurement data read out section 24, and the display device (displaying means) 28 are similar to those of the second embodiment.

The touch panel (portion specifying means) 32 and the pointing device (portion specifying means) 34 are used to specify a portion upon the display screen.

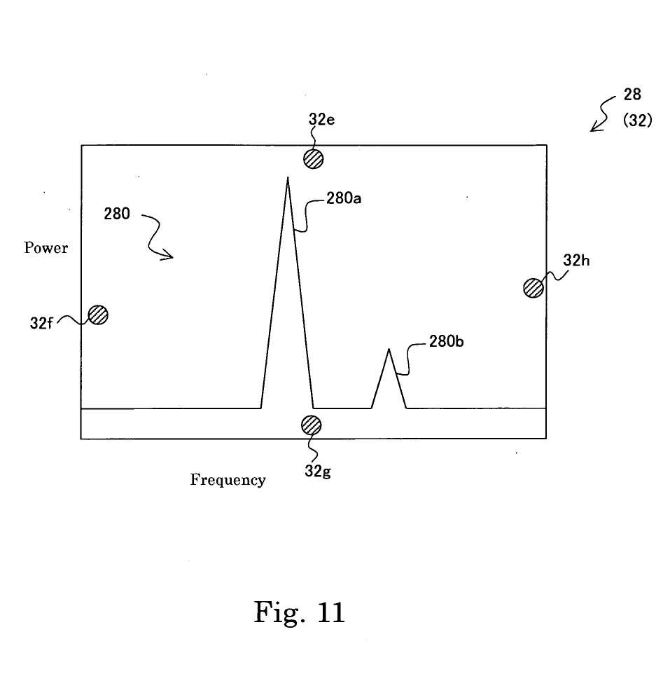

The touch panel (portion specifying means) 32 detects a touch of the finger of the user and the like. The touch panel 32 is installed upon the display screen. Thus, if the user touches the display screen by the finger or the like, the touch panel 32 detects a touched portion. A description will now be given of a method to specify a portion by means of the touch panel 32 with reference to FIG. 11.

As shown in FIG. 11, upon the display screen are an area 32e at a top portion, an area 32f at a left portion, an area 32g at a bottom portion, and an area 32h at a right portion. On this occasion, any one of the areas 32e to 32h is touched by the finger or the like.

The pointing device (portion specifying means) 34 displays the marker upon the display screen, and moves the marker according to a manipulated variable thereby specifying a portion. For example, the pointing device 34 may be a mouse. If the mouse is employed, the marker moves upon the display screen according to the amount of a movement of the mouse. A method of specifying a portion by means of the pointing device 34 is carried out to move the marker to any one of the areas 32e to 32h.

The specified portion judgment section 36 judges a coordinate of the portion specified by the touch panel 32 and the pointing device 34.

The display area decision section (operation deciding means) 42 decides an area in which the signal to be measured is displayed by the display device 28 based upon the portions specified by the touch panel 32 and the pointing device 34. The decided area is transmitted to the measurement data read out section 24, and the measurement data read out section 24 reads out measurement data within the area.

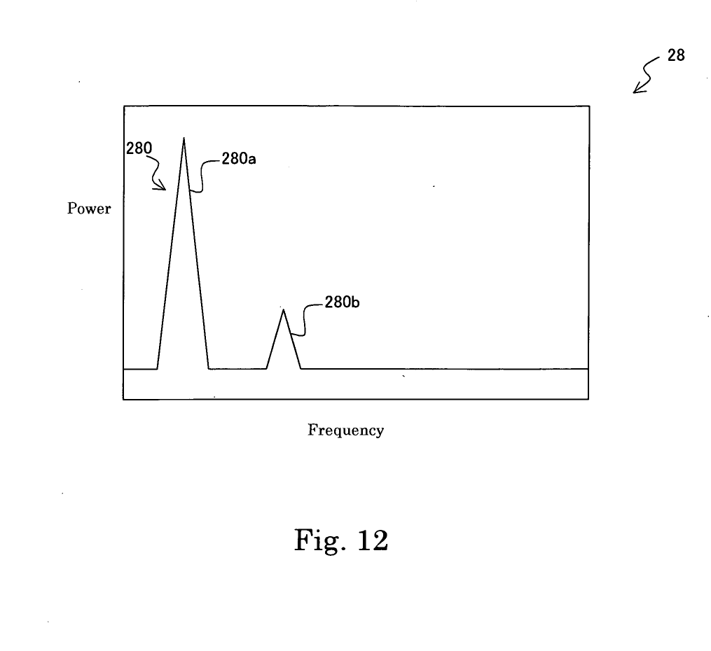

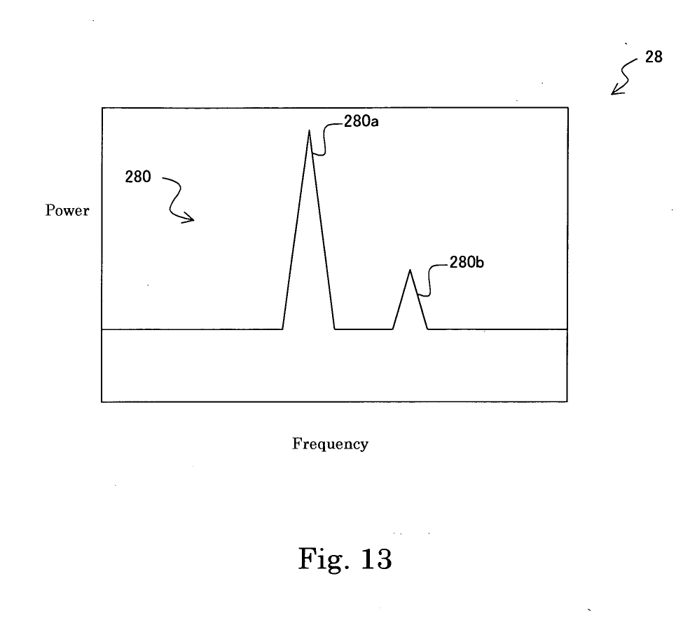

If the area 32h is specified by the finger, as shown in FIG. 12, the display area is moved right. If the area 32g is specified by the finger, as shown in FIG. 13, the display area is moved down. If the area 32e or 32f is specified by the finger, the display area is moved up or left respectively. It should be noted that the display is carried out in a similar manner for cases where the marker is moved to the respective areas 34e to 32h upon the display screen.

A description will now be given of an operation of the third embodiment.

The signal to be measured is mixed with the local signal generated by the local oscillator 12 by the mixer 14. It should be noted that the local signal is frequency-swept by the sweep signal generated by the sweep signal generator 10. The intermediate frequency filter 16 extracts the signal with the predetermined intermediate frequency from the output of the mixer 14. The signal with the predetermined intermediate frequency is detected by the detector 18 to acquire the power for the respective frequencies of the signal to be measured. The measured power is converted into the digital signal by the A/D converter 20, and is recorded in the measurement data recording section 22. It should be noted that the measured power is associated with the frequency and is recorded as the measurement data. The measurement data is read out by the measurement data read out section 24. The signal to be measured is then displayed by the display device 28 as the chart with the power being assigned to the vertical axis, and the frequency being assigned to the horizontal axis (refer to FIG. 2).

On this occasion, the user touches the area 32h upon the display screen by the finger (refer to FIG. 11). The touch panel 32 installed upon the display screen then detects the touch of the finger. The specified portion judgment section 36 judges which of the areas 32e to 32h the portion specified by the touch panel 32 is. Upon the touch of the finger within the area 32h, the display area decision section 42 decides to move the display area right (refer to FIG. 12), and transmits the decision to the measurement data read out section 24.

Alternatively, the user moves the marker to the area 32h upon the display screen. The specified portion judgment section 36 then judges which of the areas 32e to 32h the portion specified by the pointing device 34 is. Upon the touch of the finger within the area 32h, the display area decision section 42 decides to move the display area right (refer to FIG. 12), and transmits the decision to the measurement data read out section 24.

The measurement data read out section 24 increases an upper limit and a lower limit of the frequency range of the data to be measured, which is to be read out, by the same amount. The data to be measured, which is read out by the measurement data read out section 24, is displayed by the display device 28. The display area moves right (refer to FIG. 12). This operation is a so-called scroll.

According to the third embodiment, it is possible to set a portion to be displayed by touching the display screen by the finger or moving the marker using the pointing device 34 such as the mouse. Thus, the setting of the display area (so-called scroll) can be easily carried out.

Moreover, the above-described embodiments may be realized in the following manner. A computer is provided with a CPU, a hard disk, and a media (such as a floppy disk (registered trade mark) and a CD-ROM) reader, and the media reader is caused to read a medium recording a program realizing the above-described respective parts such as the peak judgment area decision section 38, the zoomed-in area decision section 40, and the display area decision section 42, thereby installing the program on the hard disk. This method may realize the above-described functions.

1. A signal measurement/display device comprising:
a measuring means that measures a signal to be measured for respective frequencies, and outputs a measurement value;
a displaying means that displays the signal to be measured with the measurement value being assigned to one axis, and the frequency being assigned to another axis;
a portion specifying means that specifies a portion upon a display screen of said displaying means; and
an operation deciding means that decides an operation of said measuring means or said displaying means based upon the portion specified by said portion specifying means.

2. The signal measurement/display device according to claim 1, wherein said portion specifying means specifies the portion according to a touch to the display screen.

3. The signal measurement/display device according to claim 1, wherein said portion specifying means specifies the portion by moving a marker upon the display screen according to a manipulated variable.

4. The signal measurement/display device according to claim 1, wherein said operation deciding means decides a detection range for said measuring means to detect a maximal value of the measurement value based upon the portion specified by said portion specifying means.

5. The signal measurement/display device according to claim 4, wherein said operation deciding means decides the detection range based upon a value obtained by adding or subtracting a predetermined value to or from a coordinate of the portion specified by said portion specifying means.

6. The signal measurement/display device according to claim 4, wherein said operation deciding means decides the detection range based upon an area enclosed by the portions specified by said portion specifying means.

7. The signal measurement/display device according to claim 1, wherein said operation deciding means causes said displaying means to zoom in or out the signal to be measured based upon the portions specified by said portion specifying means.

8. The signal measurement/display device according to claim 7, wherein said operation deciding means zooms in the signal to be measured between frequency components of coordinates of two portions specified by said portion specifying means.

9. The signal measurement/display device according to claim 1, wherein said operation deciding means scrolls an area for said displaying means to display the signal to be measured based upon the portion specified by said portion specifying means.

10. The signal measurement/display device according to claim 9, wherein said operation deciding means scrolls the area for said displaying means to display the signal to be measured based upon a position of the portion specified by said portion specifying means upon the display screen.

11. A signal measurement/display method of a signal measurement/display device having: a measuring means that measures a signal to be measured for respective frequencies, and outputs a measurement value; a displaying means that displays the signal to be measured with the measurement value being assigned to one axis, and the frequency being assigned to the other axis; and a portion specifying means that specifies a portion upon a display screen of said displaying means, said method comprising:
an operation deciding step of deciding an operation of said measuring means or said displaying means based upon the portion specified by said portion specifying means.

12. A signal measurement/display device comprising:
a detector that measures a signal to be measured for respective frequencies, and outputs a measurement value;
a display that displays the signal to be measured with the measurement value being assigned to one axis, and the frequency being assigned to another axis;
an input device that specifies a portion upon a display screen of the display; and
a decision section that decides an operation of the input device or said display based upon the specified portion.

13. The signal measurement/display device according to claim 12, wherein the input device comprises a touch panel.

14. The signal measurement/display device according to claim 12, wherein the input device specifies the portion by moving a marker on the display screen according to a manipulated variable.

15. The signal measurement/display device according to claim 12, wherein the decision section decides a detection range for the input device to detect a maximal value of the measurement value based upon the specified portion.

16. The signal measurement/display device according to claim 15, wherein the decision section decides the detection range based upon a value obtained by adding or subtracting a predetermined value to or from a coordinate of the specified portion.

17. The signal measurement/display device according to claim 15, wherein the decision section decides the detection range based upon an area enclosed by the specified portions.

18. The signal measurement/display device according to claim 12, wherein the decision section causes the display to zoom in or zoom out the signal to be measured based upon the specified portions.

19. The signal measurement/display device according to claim 18, wherein the decision section zooms in the signal to be measured between frequency components of coordinates of two portions specified by the input device.

20. The signal measurement/display device according to claim 12, wherein the decision section scrolls an area for the display to display the signal to be measured based upon the specified portion.

21. The signal measurement/display device according to claim 20, wherein the decision section scrolls the area for the display to display the signal to be measured based upon a position of the specified portion on the display screen.
